(19) United States
(12) Patent Application Publication
(10) Pub. No.: US 2010/0196658 A1
(43) Pub. Date: Aug. 5, 2010

(54) Layer composite as a support for ceramic, stone or similar coverings

(75) Inventor: Juergen Weller, Iserlohn (DE)

Correspondence Address: COLLARD & ROE, P.C., 1077 NORTHERN BOULEVARD, ROSLYN, NY, 11576, US

(73) Assignee: Schlueter-Systems KG

(21) Appl. No.: 12/657,628

(22) Filed: Jan. 25, 2010

(30) Foreign Application Priority Data
Feb. 3, 2009 (DE) 20 2009 001 255.7

(51) Int. Cl. B32B 3/10

(52) U.S. Cl. 428/134; 428/138

(57) ABSTRACT

A layer composite as a support for ceramic, stone or similar coverings is constructed from a number of layers connected to one another, namely a drainage system layer, a water-tight, elastic film and a fleece. The drainage system layer is a spacing mesh which is provided on its upper side with a covering fleece, the covering fleece being equipped with through holes distributed over the whole surface of the spacing mesh.

The invention relates to a layer composite as a support for ceramic, stone or similar coverings, in particular tiles.

The provision of ceramic coverings, in particular ceramic tiles, in building interiors and exteriors is known. These ceramic coverings are generally laid using the so-called thin bed method. This method, in association with the materials used, gives rise, however, to a number of problems. It must therefore be ensured that the ceramic coverings adhere well to a supporting substructure with the aid of a tile adhesive. Furthermore, for applications in “wet areas” a sealing and drainage system must be provided since unavoidable moisture stresses which penetrate through the ceramic coverings, and in particular through the joins between the coverings, collect beneath the ceramic coverings as backwater. In particular with ceramic coverings in outdoor areas, due to changing temperature stresses this type of backwater can lead to destruction of the tiles or substrates and wash out essential components of the joint adhesives used so that the latter lose their strength, or in the worst case seep into the substructure and destroy the latter. Moreover, due to the different heat expansion coefficients of the ceramic coverings and the components of the supporting substructure, changes in temperature also lead to stresses which, in particular when floors are subject to stresses, can lead to cracks in the ceramic coverings or joints. Therefore, with known supporting structures for ceramic coverings a sealing system together with a drainage system is already provided in which cavities are provided so that also due to an incline the backwater can independently flow out of this supporting structure and the structure can be aerated.

In document DE 299 24 180 U1 a support plate for this type of floor structure is described. This support plate comprises an embossed synthetic film which has a fleece adhesively bonded to one or both sides, the fleece on the lower side serving to bond the support plate better to the substrate. The embossed synthetic plate or film is very stiff because the stampings are intended to provide a weight-bearing structure and serve to break down tensions when subjected to stress. Furthermore, the stampings and recesses are arranged such that they form drainage channels so that backwater can flow away. A disadvantage with this supporting structure is, however, that depending on the installation location of the support plates, water which has penetrated in will possibly not flow away immediately or completely. Furthermore, due to the stiff construction of the embossed synthetic plate, one can only package easily transportable pieces or panels.

It is therefore the object of the present invention to improve the support for ceramic coverings such that the floors are well sealed against penetrating moisture, there is good anchoring of the ceramic coverings, the required mechanical load capacity of the ceramic coverings is guaranteed, the drainage function is improved, without the structure of the support for the ceramic coverings being more complex and therefore more expensive.

This object is achieved with a layer composite as a support for ceramic, stone or similar coverings with the features of Claim 1. This layer composite is applied, preferably adhered, for example, to a surface of a substrate, for example a screed base, produced with a 1% or 2% incline. The layer composite is made up of at least four layers connected to one another, listed from the bottom to the top these being a fleece, a water-tight elastic film, a spacing mesh and a perforated fleece.

The fleece finishing off the lower side of the layer composite is preferably made of synthetic fibres, particularly preferably of polypropylene fibres. The fleece can be a staple fibre fleece or a needle fleece. A fleece layer with a density of at least 10 g/m² is sufficient, but 30 g/m² or more is preferred. This fleece serves to anchor the layer composite onto the screed base and is connected to the film disposed over the latter. This connection can be achieved by means of a separate adhesive layer. Another possibility is for the film to be connected to the fleece in a warm state during production of the layer composite by lamination or cementing, binding onto the fleece being implemented by the consistency of the film which is still sticky.

The film disposed over the fleece is made of a water-tight elastic plastic, preferably polyethylene or polypropylene. The thickness of the film is chosen such that it has sufficient strength for the intended application, film thicknesses of at least 0.2 mm having proved to be sufficient. Depending on the production process of the layer composite, this type of synthetic film can also be formed with three layers, namely a core layer made of polyethylene and/or polypropylene which is coated on one or both sides with an adhesive layer, these adhesive layers serving to provide on the one hand a connection with the fleece, and on the other hand a connection between the core layer and the spacing mesh. This synthetic foil is water-tight and preferably also resistant to acids and lyes. It thus guarantees that water which penetrates through the ceramic coverings, through cracks in the tiles and through the joints provided between the tiles can not penetrate into the substrate, in particular of buildings. This water is discharged above the film in the region of the spacing mesch. The spacing mesh thus takes on the drainage function and constitutes a drainage system layer.

The spacing mesh is a custom-made product made of base-resistant meshed threads, for example polyester threads or polyolefin threads, preferably of polypropylene threads. Despite the open structure with up to 95% pore spaces, the spacing mesh produced like a mat has sufficient compression hardness which is required for the use of the composite. Furthermore, it enables optimum heat and moisture regulation due to the cavities provided in this mesh between the threads of the mesh, and the mats can easily be rolled up. The spacing mesh is preferably an extruded product. It can also be produced in other ways, for example from a mass of threads which is folded by means of a pleating process and in this way is given its desired thickness. These aforementioned spacing meshes can be produced in different thicknesses. For the present application spacing meshes with a thickness of 1 mm to 10 mm, preferably 2 mm to 4 mm, are provided. This type of spacing mesh in the layer composite according to the invention as a support for ceramic tiles thus guarantees the good drainage function of this layer composite.

The surface of the spacing mesh is covered by a perforated covering fleece. The covering fleece finishing off the upper side of the layer composite is made, for example, of polyester or polyolefin fibres, preferably of polypropylene fibres. The covering fleece can be a staple fibre fleece or a needle fleece. A fleece layer with a density of at least 10 g/m² is sufficient, but 30 g/m² or more is preferred. This covering fleece serves to separate the spacing mesh from planar penetration of the tile adhesive. Through holes are made in the covering fleece. These perpendicularly extending through holes extend as far as the spacing mesh. These through holes made are distributed over the whole surface of the covering fleece. In a preferred embodiment there is an even distribution of the through holes. In this way the compressive load which is applied onto the ceramic coverings from above can be distributed evenly over the layer composite since the tile adhesive provided in order to attach the ceramic coverings penetrates into these through holes. Therefore, if a layer composite according to the invention is attached onto the screed base and tile adhesive is then applied, the tile adhesive penetrates through the through holes of the covering fleece into the spacing mesh, and forms column-like structures of equal height in the spacing mesh beneath the through holes of the covering fleece. These columns of tile adhesive are well anchored by connecting to the meshed threads of the spacing mesh, and after the setting of the tile adhesive guarantee good stability in the layer composite for the ceramic covering which lies evenly over these tile adhesive columns. Since the tile adhesive is applied in a pasty, viscous state, it only penetrates into the regions of the spacing mesh where the covering fleece disposed on the surface of the spacing mesh has through holes. Sufficient space remains in the spacing mesh in order to perform the drainage function. After setting the tile adhesive has sufficient stability in order to absorb the compressive load of the ceramic floors. The spacing mesh has a high degree of compression hardness. This means that the mesh is deformed neither upon laying the layer composite nor by stresses applied to the surface provided with tile adhesive, e.g. by being walked over. In this way the layer composite according to the invention guarantees the required mechanical carrying capacity.

The through holes in the covering fleece can have any cross-section, such as for example round, oval, square or polygonal cross-sectional shapes. Preferred are round through holes, the width of the through holes or of the diameters of the through holes being between 3 mm and 20 mm, preferably between 8 mm and 12 mm.

The composite according to the invention can advantageously be used as a support for ceramic or similar coverings, in particular tiles, and has both a good drainage function and a good sealing function, combined in the layer composite according to the invention. Furthermore, this layer composite is free from stresses, and due to its composition quietens impact noise. Moreover, this layer composite made up of the four layers, namely covering fleece, spacing mesh, synthetic film and fleece, can easily be processed during the production process into specific formats as are generally used in construction. In order to provide a very large area with a ceramic covering, in addition to the layer composites processed into formats, rolls of a rolled up strip of layer composite in desired widths, for example 1 m, 1.20 m, 1.50 m can also advantageously be provided, since all of the layers of the composite are flexible. The pieces of layer composite according to the invention are laid onto the screed coated with tile adhesive before applying the ceramic or other coverings, the individual pieces of layer composite being laid such that they abut one another directly. In order to seal the joints between two pieces of layer composite a known splicing strip, preferably a strip of fleece coated on one side with adhesive, is provided, for example, beneath the pieces of layer composite. In this way the splices are also sealed.

With a preferred embodiment, with a piece of layer composite produced the fleece is provided offset to the spacing mesh so that the fleece projects over one side of the spacing mesh, and the spacing mesh projects over the fleece on the opposite side. However, the synthetic film disposed between both is provided in a width which covers the whole surface of both the spacing mesh and the fleece. An advantage of this arrangement of the layers in the layer composite according to the invention is that when laying these pieces of layer composite a water-tight arrangement can easily be guaranteed because upon joining together these pieces of layer composite in the connection region one synthetic film of the one part always comes to lie on or beneath a synthetic film of the other layer composite part.

In addition, in this connection region an adhesive strip can be provided on the lower side of the film provided with fleece, being applied to the projecting end of fleece-free film. For the water-tight laying and connection of two pieces of layer composite, after removing the protective film or the protective paper, this adhesive strip is stuck against the upper side of the film of a next piece of layer composite in the region in which the film projects over the spacing mesh to the side. By pushing down forcefully, for example by means of a roller, both parts of the adhesive composite are connected, the connection points being formed such as to be water-tight, as are the individual pieces of layer composite already. Further pieces of layer composite can be laid in the same way. Therefore, water-tight laying of the layer composite onto the screed base is easily guaranteed.

In the following, using exemplary embodiments, the invention is described in greater detail by means of the drawings. These show as follows:

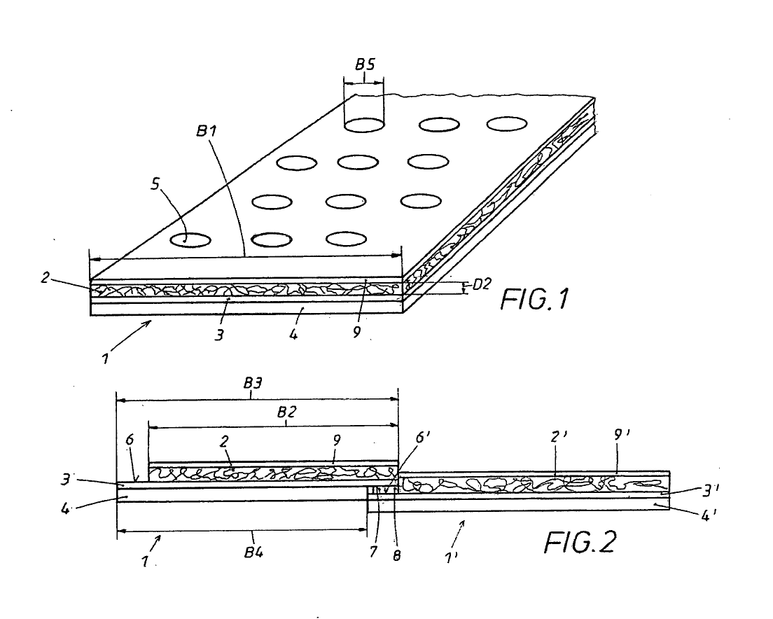

FIG. 1a perspective view of a layer composite according to the invention,

FIG. 2a side view of two pieces of layer composite disposed next to one another and connected.

In FIG. 1a perspective view of the layer composite 1 according to the invention is shown, from the bottom to the top this layer composite 1 according to the invention comprising a fleece 4, a water-tight film 3, a spacing mesh 2 and a covering fleece 9. This type of layer composite 1 is adhered by means of tile adhesive onto the screed base, care being taken to ensure that the screed base has an incline of 1.5% to 2%. This incline makes it possible for the water that has penetrated into the layer composite 1 to flow away independently.

In this case the fleece 4 is made of polypropylene fibres which provide a good connection to the tile adhesive. Above the fleece 4 a water-tight polyethylene foil is provided which is laminated onto the fleece 4 during the production process. Therefore, this film 3 guarantees that the water, which penetrates through the ceramic floors, flows away above this foil, and so protects the screed substrate against water damage. The film 3 is connected to a spacing mesh 2 which is made 100% of polypropylene and has a thickness D2 of 3 mm. The surface of the spacing mesh 2 is covered with a covering fleece 9. This covering fleece 9 is made of polypropylene filaments and has through holes 5, distributed evenly over the whole of its surface, which extend from the surface of the covering fleece 9 as far as the spacing mesh 2. In this case the through holes have a round cross-section with a diameter B5 of 8 mm. If such a layer composite 1 is laid onto the screed base, the tile adhesive provided in order to attach the ceramic tiles is applied, and this flows through the through holes 5 of the covering fleece 9 into the spacing mesh 2, and after setting forms supporting columns for the ceramic floor covering. With the present layer composite a compression hardness of 72 kPa was measured.

This type of layer composite 1 according to the invention can be offered in specific desired formats, i.e. in a desired width B1 and in a desired length. It is also possible, in particular for laying large areas, to produce strips of the layer composite 1 for example in standardised widths B1 of 1 m, 1.20 m, 1.50 m and lengths of 1 m to 3 m. Due to the resiliently flexible form and the relatively small overall thickness of the layer composite according to the invention, these strips can be provided rolled up into a roll, for example in pre-specified lengths of 5 m, 10 m, 30 m, 50 m or other lengths.

FIG. 2 shows a further possible embodiment of a layer composite 1, 1′. Both pieces of layer composite 1, 1′ are constructed with four layers, namely a fleece 4, 4′, a water-tight film 3, 3′, a spacing mesh 2, 2′ and a covering fleece 9, 9′ with corresponding through holes 5 which are not shown in FIG. 2. The layer composite 1 in FIG. 2 shows a film 3 with a width B3 which is greater than the width B2 of the spacing mesh 2, so that a projection 6 is produced on the left-hand side of the layer composite in FIG. 2. On the other hand, the width B3 of the film 3 is also greater than the width B4 of the fleece 4 so that a shoulder 7 is produced on the right-hand side of the layer composite, see FIG. 2. The piece of the layer composite 1′ disposed adjacent to this is formed in the same way on the left-hand side, i.e. it also has a projection 6′. On the right-hand side the ends of the four layers 9′, 2′, 3′ and 4′ are aligned. This is an edge piece. In the same way a shoulder 7′ could also be provided here if this part of the layer composite 1′ is to be adhered on its right-hand side to a further piece of a layer composite. As can be seen from FIG. 2 the pieces of the layer composite 1′ overlap in the region of the shoulder 7 or of the projection 6′. In this example, an adhesive strip 8 is disposed between the film 3 in the region of the shoulder 7 and the film 3′ in the region of the projection 6′. This can be a rubber adhesive strip or an acrylic adhesive strip. This adhesive strip guarantees a secure connection between the two adjacent regions of the film 3, 3′, and so a water-tight connection in the region of the connection point of the layer composites 1, 1′ is guaranteed. In order to give a better overview, FIG. 2 shows the two pieces of the layer composite 1 and 1′ before the formation of the connection. After the formation of the connection both the upper and the lower sides of both pieces of the layer composite 1 and 1′ are aligned.

Of course, when using layer composites 1, as shown in FIG. 1, this type of connection point without projections 6 and shoulders 7 can be laid in the known way, such as to be water-tight, using adhesive strips. In this case the adhesive strips are attached to the lower side of the layer composite 1, i.e. on the fleece 4. The adhesive strips can also be provided on the upper and lower side of the layer composite. Furthermore, sealing by means of sealing medium applied at the construction site in the form of beads, is also possible.

The invention is not restricted to the exemplary embodiment shown.

### LIST OF REFERENCE NUMBERS

1, 1′ layer composite

2, 2′ spacing mesh

3, 3′ film

4, 4′ fleece

5 through hole

6, 6′ projection

7 shoulder

8 adhesive film

9, 9′ covering fleece

B1 width of 1

B2 width of 2

B3 width of 3

B4 width of 4

B5 diameter of 5

D2 thickness of 2

### CITATIONS INCLUDED IN THE DESCRIPTION

This list of documents given by the Applicant has been produced by automated means and is included purely to better inform the reader. The list is not a component part of the German Patent and Utility Model Application. The DPMA (German Patent and Trademark Office) does not accept any liability for any errors or omissions.

### Cited Patent Literature

DE 29924180 U1 [0003]

1. A layer composite (1, 1′) as a support for ceramic, stone or similar coverings, constructed from a number of layers connected to one another, namely a drainage system layer, a water-tight, elastic film (3, 3′) and a fleece (4, 4′), wherein the drainage system layer is a spacing mesh (2, 2′) which is provided on its upper side with a covering fleece (9, 9′), the covering fleece (9, 9′) being equipped with through holes (5) distributed over the whole surface of the spacing mesh (2, 2′).

2. The layer composite (1, 1′) according to claim 1, wherein the through holes (5) of the covering fleece (9, 9′) are provided evenly over the whole surface of the covering fleece (9, 9′).

3. The layer composite (1, 1′) according to claim 1, wherein the through holes (5) have a round, oval, square or polygonal cross-section and preferably have a width B5 of 3 to 20 mm, particularly preferably 8 to 12 mm.

4. The layer composite (1, 1′) according to claim 1, wherein the spacing mesh (2, 2′) is made of the same or different synthetic threads, preferably of polyester threads, and has a thickness D2 of 1 to 10 mm, preferably 2 to 4 mm.

5. The layer composite (1, 1′) according to claim 1, wherein the elastic film (3, 3′) is made of plastic, preferably of polyethylene or polypropylene.

6. The layer composite (1, 1′) according to claim 1, wherein the elastic film (3, 3′) is constructed from three layers connected to one another, namely a core layer made of polyethylene or polypropylene which is coated on both sides with an adhesive layer.

7. The layer composite (1, 1′) according to claim 1, wherein the fleece (4, 4′) is constructed from polypropylene fibres.

8. The layer composite (1, 1′) according to claim 1, wherein the covering fleece (9, 9′) is constructed from polyester fibres or polyolefin fibres.

9. The layer composite (1, 1′) according to claim 1, wherein the resiliently flexible layer composite (1, 1′) can be produced in a desired width B1, preferably in a width B1 of 1 m, 1.20 m or 1.50 m, and in desired lengths, preferably 1 m to 3 m, and as cut-to-size pieces or rolled up as a roll for use.

10. The layer composite (1, 1′) according to claim 1, wherein the resiliently flexible layer composite (1, 1′) in the desired width B1 has a spacing mesh (2, 2′) with a width B2, a film (3, 3′) with a width B3 and a fleece (4, 4′) with a width B4, for water-tight laying the film (3, 3′) preferably having a greater width B3 than the width B2 of the spacing mesh (2, 2′).

11. The layer composite (1, 1′) according to claim 10, wherein the film (3, 3′) projects over the spacing mesh (2, 2′) at least on one side and forms a projection (6, 6′).
